(19) United States
(12) Patent Application Publication
(10) Pub. No.: US 2014/0193566 A1
(43) Pub. Date: Jul. 10, 2014

(54) Gel Particles in Cheese

(71) Applicant: Peter Haefeli, Triengen (CH)

(72) Inventor: Peter Haefeli, Triengen (CH)

(73) Assignee: Peter HAEFELI, Triengen (CH)

(21) Appl. No.: 14/240,236

(22) PCT Filed: Aug. 23, 2011
(86) PCT No.: PCT/EP2011/064464

§ 371 Date: Mar. 13, 2014

(51) Int. Cl. A23C 19/09

(52) U.S. Cl. CPC A23C 19/0925
USPC 426/582

(57) ABSTRACT

The invention relates to a cheese containing gel particle inclusions. Gel particles are different in taste, texture color, flavor and origin compared to the cheese matrix, of fresh-, soft-, semi-hard or hard cheese type.

### TECHNICAL FIELD OF THE INVENTION

The present invention relates to a cheese or similar goods, containing gel particles with different flavor, texture taste and color and origin compared to the cheese matrix.

### BACKGROUND OF THE INVENTION

A wide variety of different cheeses exist, ranging from dry and firm hard cheeses to soft and moist ones. Not only cheese bulk texture can be different but also flavor, color or surface. Origin of milk (e.g. from cow, goat) has an influence on texture, flavor etc as well. Inclusions like air bubbles (e.g. Swiss cheese like Emmentaler) or microorganisms in air pockets (e.g. Blue Vein cheese like Gorgonzola) are on the market. Moreover, inclusions of fruits pieces, vegetables (e.g. herbs in fresh cheeses) or nuts are well known, too.

Cheese production may vary depending on the type of cheese but in general, it can be described according to Law and Tamime 2010, as following:
1. standardization of fat
2. heat treatment of milk
3. addition of starter culture
4. coagulation and cutting of curd
5. stirring, heating and syneresis
6. whey removal, hopping and pressing
7.storage for ripening/maturing

Within point 5., heating may vary depending on the type of cheese for soft cheese 30-34° C., for semi-hard cheese 34-42° C. and for hard cheese 45-56° C.

Chocolate is a fat based crystallized suspension with a melting range of around 27° C. to 33° C., depending on the type of polymorph and chocolate (Beckett 1999). Adding chocolate to cheese during production will consequently result in a melted chocolate, evenly distributed over the cheese bulk without firm and distinct pieces in the cheese matrix. Cheese with evenly distributed chocolate or cocoa solids is described in NL1005903 C1 for example.

In DE10043573 A1 a cheese product is described, having 2 cheese phases, one phase of cheese, containing evenly spread chocolate, fruit or other flavors and the other, having cheese with no other addition. A marble like cheese texture is the result of such a set up.

In DE10121913 A1, a sandwich type of fresh cheese is described; comprising one fresh cheese phase with evenly distributed chocolate or chocolate paste whereas in the two neighboring phases, fresh cheeses with whole chocolate pieces are present. Heat treatment of fresh cheese is not as severe as with soft, semi-hard or hard cheeses and therefore it is possible to mix chocolate pieces into fresh cheeses at low temperatures, namely below chocolate melting. Moreover, fresh cheese can be easily mixed and is more like a spreadable paste, not having a firm texture as the above-mentioned cheese varieties have.

Another fresh cheese type can be produced by high shearing one part of fresh cheeses containing flavors like vanilla, cocoa, chocolate, coffee, fruits etc., and co-extruding it with another, highly sheared fresh cheese with no additional flavors (WO2005099470A1). This type of cheese does not have inclusions but 2 separate bulk phases.

In WO2010038064A1, mesoporous silicon microparticles of 20 μm are loaded with sensitive food ingredients like oil/fats, vitamins, aromas, enzymes etc., encapsulated by a crystallized fat or gel layer and then added to food, e.g. cheese.

### SUMMARY OF THE INVENTION

The object of the present invention is to create a cheese with gel particle inclusions of different taste and texture compared to the bulk cheese.

These gel particles do not contain any cheese but include biopolymers exhibiting gelling properties as well as other constituents, which are selected from nutrients, structure-forming agents, flavorings, aromas, coloring and/or dietary and non-dietary fibers. Additionally, gel particles may include sub-microstructures such as oil droplets and/or insoluble particles and/or air bubbles. Such gel particles might have a softer, similar or harder texture compared to the type of cheese, such as soft-, semi-hard- or hard cheese, preferably for semi-hard- or hard cheese.

In a further embodiment, such gel inclusions may be build-up by agglomerated, small gel particles.

### DETAILED DESCRIPTION OF THE EXEMPLARY EMBODIMENTS

Gel Inclusions and Incorporation into Cheese:

Biopolymers in the context of the present application refer to polymers made of the edible polymeric building blocks occurring in nature. Primarily, this term comprises all types of structure-forming'agents in the form of polysaccharides, which are considered also to include the majority of hydrocolloids suitable to foodstuff purposes. Examples of suitable hydrocolloids, which may be mentioned, are products such as xanthan, carrageenan or various plant gums, while other polysaccharide constituents, which may be mentioned, are in particular starches, for example cocoa starches. In addition of gel structure-forming polysaccharides, recipes of the inventive food products may comprise other constituents to be counted as biopolymers such as all types of proteins, in particular milk proteins, egg proteins or proteins of plant origin. The content of biopolymers in the gel particle inclusions is generally in the range of 0.01-35% by weight. The biopolymer solvent is of aqueous nature, in particular water, milk or various fruit juices. The content of water in the gel particles can vary over a wide range and is generally in the range of 30-95% by weight.

In addition to the constituents, which can be termed functional ingredients as structure building biopolymers and water, the gel particle inclusions further comprise customary other constituents which promote the gel particle inclusion properties and/or consumer properties. Without any claim as to completeness, these constituents include nutrients, for example fats, oils and sugars, flavorings and aromas, for examples sugars, honey, sugar aromas, fruit aromas, alcohol or alcohol aromas, fruit extracts, salt, spicing and seasonings and similar customary constituents. In addition, food constituents can be present which, depending on their function, can be termed thickeners, structure-forming agents or dietary and non-dietary fibers, and, obviously, the gel particle inclusions can also comprise natural, nature-identical or synthetic colorings and other food additives, as are customary for food products of the inventive type. It is in addition provided that puree and/or pieces for example of fruits, vegetables, nuts, meat and/or fish can be added to the gel particles which can be prepared accordingly to the invention. Moreover, air, nitrogen or any other food-graded gas can be incorporated into the gel particles. Size of inclusions may vary, between 5 μm to 3 cm, preferable between 1 mm and 2 cm. Shape of gel particles can be irregular or spherical.

Gel particle inclusions can be produced in different ways. One avenue is to generate a conventional, continuous gel network. Such a gel is then broken up into smaller pieces in a mill, a blade mixer, stamping knife or other appropriate process units. Gel particles are then added to the cheese curd and mixed. If the curd is subjected to high shear, gel particles can be added after such a shearing process in order to keep the gel particle shape. Cheese containing gel particle inclusion is then processed further according to the cheese type. In another possible process, gel particles are created by spraying a gelling solution into hot moist air or in case of alginate, into a calcium bath. Furthermore, gel particles can be dried and added as dry solid particles to the cheese. In another embodiment, gels are cut in very small pieces (below 50 μm) and then agglomerated to bigger pieces in the size as mentioned before. Such agglomerated gel pieces are the added to the curd under minimal shearing.

### EXAMPLES

The following examples are not intended to limit the scope of the invention, but merely to illustrate representative possibilities concerning the present invention.

Ingredients:

| | melted | cocoa | | | ground | | |
|---|---|---|---|---|---|---|---|
| | chocolate | powder | NFDM | WPI | hazelnuts | sugar | water |
| 1 | 25% | 6% | 8% | 6% | — | 10% | 45% |
| 2 | 30% | 5% | 10% | 5% | 10% | — | 40% |
| 3 | 40% | 10% | 10% | 5% | — | — | 35% |
| 4 | 40% | 5% | 10% | 5% | — | — | 40% |

Legend:
NFDM: Non Fat Dry Milk powder
WPI: Whey protein isolate

| | raspberry puree | Pectin gelling agent | sugar |
|---|---|---|---|
| 5 | 41.7% | 16.6% | 41.7% |

Legend: Pectin gelling agent (gelling agent for jams from Migros)

Manufacturing of Gel Particle Inclusions:

Ingredients were
(a) mixed and dissolved in a high shear mixer and then transferred to glass jars
(b) sealed and cooked at 120° C. for 30 minutes to induce a continuous gel network and to sterilize the gel
(c) after cooling to room temperature, the continuous gel was
(d) cut into gel particles with a knife (by hand for example)

Manufacturing of Cheese with Gel Particle Inclusions:
(e) after milk pasteurization, 0.16% starter culture for semi-hard cheese were added at 32° C. and ripened. for 45 minutes
(f) adding rennet at 32° C., incubation time 32 minutes
(g) cutting of curd into 2-3 mm big pieces. Stirring for 10 minutes
(h) partially removal of whey (30%) by water of 50° C., heating of curd to 40° C. and stirring for another 15 minutes
(i) adding and hand mixing of gel particles (10% w/w) to the curd from step (d)
(j) depositing of the mixture into molds
(k) applying two bar pressure to press out whey for 10 minutes, turn-over cheese and press for another 20 minutes at three bar, turn-over cheese again and pressing for 40 minutes at four bar.
(l) drain cheese at 35° C.
(m) soak cheese for three hours in salt bath (pH 5.4, 20-21 Baumé)
(n) ripening cheese at 13° C. and 90% RH.

1. A cheese, containing gel particle inclusions, which are different in flavor, texture, color and origin compared to the bulk cheese.

2. The cheese of claim 1, wherein the Cheese is of fresh-, soft-, semi-hard or hard cheese type containing gel particle inclusions.

3. The cheese of claim 2, comprising at least one further constituent of the gel particle inclusions selected from the group consisting of nutrients, biopolymers structure-forming agents, fats and oils, dietary and non-dietary fibers, flavorings, aromas, colorings and combinations thereof.

4. The cheese of claim 3, wherein gel particles may have an additional sub-microstructure in form of droplets, insoluble particles or gas bubbles.

5. The cheese of claim 1, wherein the biopolymers of the gel particle inclusions are polysaccharides or proteins.

6. The cheese of claim 1, wherein the flavor or taste of the gel particle inclusions is sweet and/or sour and/or salty.

7. The cheese of claim 5, wherein the polysaccharides are starches, namely of plant origin including cocoa starches and hydrocolloids are xanthan, carrageenan, locus gum or microcrystalline cellulose, the biopolymers are present in an amount in the range from 0.01 to 40% by weight and optionally containing fats in the amount of up to 30% by weight.

8. The cheese of claim 1, wherein the gel network of the gel particle inclusion is build up by cocoa and milk proteins only, and other typical chocolate ingredients are present.

9. The cheese of claim 1, wherein sweetener of the gel particle inclusions can be of nutritive or non-nutritive, natural or artificial nature in the range of 0.01 to 50% by weight.

10. The cheese of claim 1, wherein gel particle inclusions are of spherical or irregular shape and in the size range of 0.1 to 30 mm.

11. The cheese of claim 1, where gel particles consists of an agglomeration of very small gel particles (below 100 μm).

12. The cheese of claim 1, wherein fruit-, vegetable-, nuts- or meat/mish puree or pieces are added to the gel particle inclusions.

13. The cheese of claim 1, where gel particle inclusions have an additional sub-structure such as liquid or crystallized fat droplets, insoluble particles or air hubbies or made in the form of a sweet confectionary or dessert, or as a product having a savory or spicy flavor and/or contain coffee or tea extracts and/or may contain alcohol.

14. The cheese of claim 1, where gel particle inclusions are dried prior to adding to the curd.

15. A method for manufacturing of cheese, containing gel Particles being different in flavor, texture, color and origin compared to the bulk cheese, the method comprising adding and mixing of said gel particles to a cheese curd, pressing out whey and draining, soaking and ripening the cheese.

16. The cheese of claim 3, wherein the biopolymers of the gel particle inclusions are polysaccharides or proteins.

17. The cheese of claim 4, wherein the gel network of the gel particle inclusion is build up by cocoa and milk proteins only, and other typical chocolate ingredients are present.
